(19) United States
(12) Patent Application Publication
(10) Pub. No.: US 2025/0377635 A1
(43) Pub. Date: Dec. 11, 2025

(54) PART WITH 3D DECORATION AND ITS MANUFACTURING METHOD

(71) Applicant: Comadur SA, Le Locle (CH)

(72) Inventors: Laurent BOURCET, Belfays (FR); Yohann MARLIER, Les Premiers Sapins (FR)

(73) Assignee: Comadur SA, Le Locle (CH)

(21) Appl. No.: 19/097,071

(22) Filed: Apr. 1, 2025

(30) Foreign Application Priority Data
Jun. 5, 2024 (EP) 24180217.2

(51) Int. Cl. G04D 3/00

(52) U.S. Cl. CPC G04D 3/0092; G04D 3/0069

(57) ABSTRACT

A method for manufacturing a part (1) made of an electrically non-conductive material, the part (1) including at least one relief decoration (2a) of a noble metal or its alloy, the method including the steps of: depositing a first adhesion layer (4a) and a second adhesion layer (4b) on the surface (2) of an ébauche (3); depositing by electroforming a layer of the noble metal or of its alloy (5) on the second adhesion layer (4b); laser cutting the layer of noble metal or of its alloy (5) to outline the relief decoration (2a); depositing a protective layer (7) around the relief decoration (2a); removing the layer of noble metal or of its alloy (5) from portions (2c) not covered by the protective layer (7); removing the protective layer (7); and removing the first adhesion layer (4a) and optionally the second adhesion layer (4b) on the portions (2c).

### CROSS REFERENCE TO RELATED APPLICATIONS

This application is claiming priority based on European Patent Application No. 24180217.2 filed on Jun. 5, 2024, the disclosures of which are incorporated by reference herein their entireties.

### TECHNICAL FIELD OF THE INVENTION

The invention relates to a method for manufacturing a part made from an electrically non-conductive material with said part having a 3D decoration made from a noble metal or its alloy.

Technological background Decorations are generally affixed, for example by gluing, to components made from hard non-conductive materials such as ceramics. Decorations affixed in this way exhibit poor adhesion to the substrate, with an increased risk of tear-off or parting, particularly on highly stressed components such as watch bezels.

### SUMMARY OF THE INVENTION

The present invention aims to remedy the aforementioned shortcomings by proposing a method for manufacturing a part with raised relief decoration wherein the risks of the decoration parting are eliminated.

More specifically, the invention relates to a method for manufacturing a part made of an electrically non-conductive material such as ceramic and sapphire, the part comprising at least one relief decoration comprised of a noble metal or its alloy, the method comprising the steps of:
Providing an ébauche designed with a surface;
Depositing a first adhesion layer on the surface and then a second adhesion layer;
Depositing by electroforming a layer of the noble metal or of its alloy on the second adhesion layer;
Laser cutting the layer of noble metal or of its alloy to outline the relief decoration;
Depositing a protective layer around the relief decoration;
Removing the layer of noble metal or of its alloy from portions not covered by the protective layer and optionally removing the second adhesion layer from said portions if the second adhesion layer is made from the same noble metal or the same noble metal alloy as the layer of noble metal or of its alloy;
Removing the protective layer;
Removing the first adhesion layer and optionally the second adhesion layer if the latter is still present after removing the layer of noble metal or of its alloy on the portions.

With the method according to the invention, the decoration cannot tear off or part from the substrate.

The present invention also relates to a part comprising at least one relief decoration overlying a base surface, said relief decoration being made of a noble metal or its alloy and having a thickness comprised between 0.02 mm and 0.7 mm, preferably between 0.03 mm and 0.3 mm, said relief decoration being joined to the base surface by a first adhesion layer and by a second adhesion layer each having a thickness comprised between 30 and 70 nm.

The layer of noble metal or of its alloy on the relief decoration is therefore very thick, up to several tenths of a millimetre. The heavy thickness of the metal or of the alloy deposited contributes to the “solid” appearance of any decoration that might have been affixed thereto, such as an applique, for example.

Since this invention is more specifically aimed at decorating bezels, there is no risk of the deposit being worn away by rubbing against clothing, which could reveal the substrate.

The electroformed noble metal alloy, in particular gold alloy, has the additional advantage of being harder than a metallurgical gold alloy that might have been affixed to the substrate. This can be used to produce a satin finish that is more durable over time.

### BRIEF DESCRIPTION OF THE FIGURES

FIGS. 1 to 9 show a schematic view of the 9 steps of the method according to the invention.

FIG. 10 shows a watch bezel with indexes and numerals forming 3D decorations made from noble metal or its alloy according to the invention.

### DETAILED DESCRIPTION OF THE INVENTION

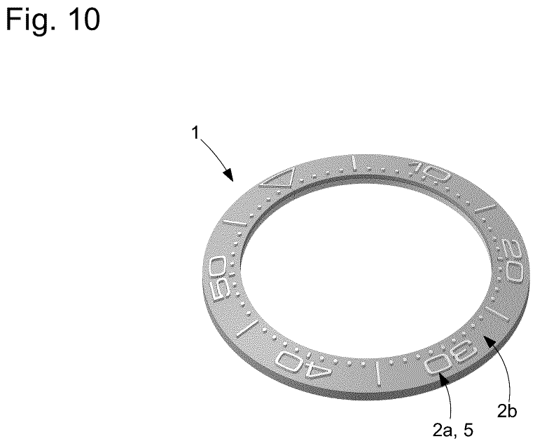

The invention relates to a method for making a part with at least one relief decoration made from a noble metal or its alloy. This part 1, shown schematically in FIG. 9 and for a bezel in FIG. 10, comprises a base surface 2b surmounted by at least one relief decoration 2a that is formed by indexes and numerals made from the noble metal or its alloy.

The noble metal is more specifically gold and its alloys, silver, platinum, palladium, rhodium or. The part can, for example, be a horology component. More specifically, it can be an external part chosen from the non-exhaustive list comprising a middle, a back, a bezel, a crown, a button, a bracelet link, a bracelet, a tongue buckle, a clasp, a dial and a hand. The method is more specifically suitable for a part made from an electrically non-conductive material such as ceramic, silicon nitride, YAG or sapphire. These materials are generally hard, with hardnesses greater than or equal to 1,100 HV.

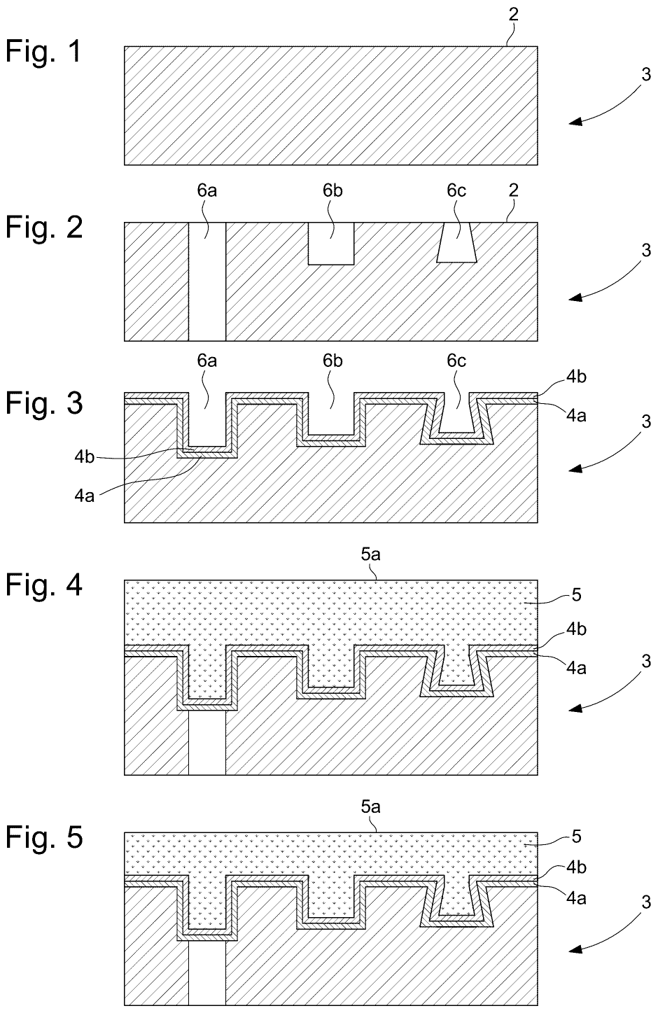

The method is illustrated in FIGS. 1 to 9 in 9 steps. In the first step (FIG. 1), an ébauche 3 of the part to be manufactured is provided. For example, it could be a bezel or a dial without the indexes. In the case of ceramics, this ébauche can be obtained by a conventional powder sintering method for ceramics, a silicon nitride and YAG, or by the Verneuil method and the EFG (Edge-defined, Film fed Growth) technique for sapphire. The ébauche 3 is designed with a surface 2 which is the side intended to include the relief decorations.

Then, in an optional second step (FIG. 2), micro-perforations 6a, engravings 6b and/or sunken reliefs 6c can be carried out on the surface 2 of the ébauche 3 to improve the anchoring of future decorations.

In a third step (FIG. 3), at least two adhesion layers 4a, 4b are deposited, preferentially by PVD (Physical Vapour Deposition), on the surface 2 and in the micro-perforations 6a, engravings 6b and/or sunken reliefs 6c. A first layer 4a is formed of Cr or of Ti and a second layer 4b is formed of Au, of Ag or of Cu. Each layer has a thickness comprised between 30 nm and 70 nm, typically with a layer on the order of 50 nm.

In a fourth step (FIG. 4), the layer of noble metal or its alloy 5 is deposited by electroforming on the second adhesion layer 4b. This layer has a thickness comprised between 0.02 mm and 0.7 mm, preferably between 0.03 mm and 0.3 mm. To grow a gold alloy in a shade comprised between the 3N and 5N ranges (according to ISO standard 8654 of February 2018), the parameters are as follows:
the bath contains from 1 to 10 g.I-1 of gold metal in the form of alkaline aurocyanide;
the bath contains from 30 to 80 g.I-1 of copper metal in the form of double alkaline cyanide;
the bath can contain from 10 mg.I-1 to 5 g.I-1 of indium metal in complex form;
the bath contains from 15 to 35 g.I-1 of free cyanide;
the temperature of the bath is kept between 5° and 80° C.;
the pH of the bath is kept between 8 and 12;
the method is carried out at current densities comprised between 0.05 and 1.5 A.dm-2.

In an optional fifth step (FIG. 5), the upper part 5a of the layer of noble metal or of its alloy 5 can be subjected to a mechanical operation in order to polish, satin-finish and/or matt this layer.

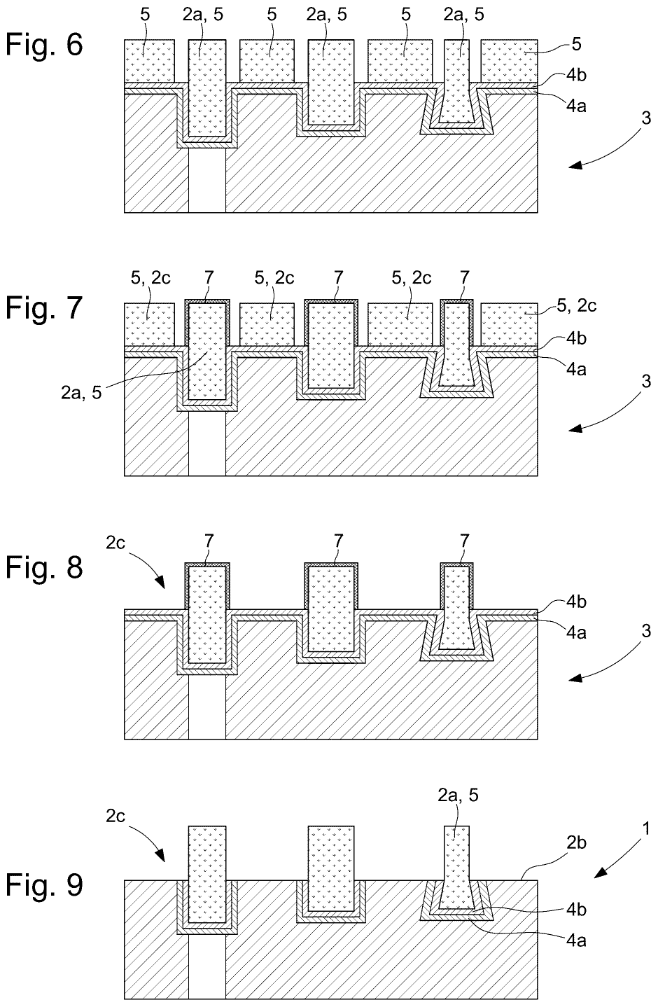

In a sixth step (FIG. 6), the future indexes and patterns that will form the relief decoration 2a are laser-cut into the layer of noble metal or of its alloy 5.

Then, in a seventh step (FIG. 7), a protective layer 7, namely a lacquer, is deposited on the future indexes and patterns 2a, leaving a layer of noble metal or of its alloy 5 not covered with lacquer on portions 2c.

In an eighth step (FIG. 8), the layer of noble metal or of its alloy 5 is removed from the uncoated portions 2c by immersing the ébauche 3 in a cyanide bath.

In a ninth step and a tenth step (FIG. 9), the lacquer 7 is removed by immersing the ebauche 3 in a Deconex 196 solvent bath and the adhesion layers 4a, 4b around portions 2c are removed by immersing the ébauche 3 in a commercial bath, for example Chrome Etch No. 1, formulated by Technic. Removing these layers has little impact on the layer of noble metal or of its alloy, as the thicknesses of the adhesion layers and the layer of noble metal or of its alloy are significantly different. Thus, removing any remaining nanometres from the adhesion layers will remove proportionally little material from the thick layer of noble metal or of its alloy.

If the adhesion layer 4b and the layer of noble metal or of its alloy 5 are made from the same noble metal, only the first adhesion layer 4a needs to be removed in this step, as the second layer 4b will have already been removed in the eighth step. It should be noted that the ninth and tenth steps can be interchanged.

In an optional eleventh step not shown, the ébauche material can be textured to give a matt, satin-finish and/or patterned appearance to the surface of the material. Texturing can be done by laser cutting or by mechanical means.

The resulting part 1, shown in FIG. 10 for a bezel, thus has one or more relief decorations 2a overlying the base surface 2b with the relief decorations 2a made of the noble metal or of its alloy 5.

1. A method for manufacturing a part (1) made of an electrically non-conductive material such as ceramic and sapphire, the part (1) comprising at least one relief decoration (2a) comprised of a noble metal or its alloy, the method comprising the steps of:
providing an ébauche (3) designed with a surface (2);
depositing a first adhesion layer (4a) and then a second adhesion layer (4b) on the surface (2);
depositing by electroforming a layer of the noble metal or of its alloy (5) on the second adhesion layer (4b);
laser cutting the layer of noble metal or of its alloy (5) to outline the relief decoration (2a);
depositing a protective layer (7) around the relief decoration (2a);
removing the layer of noble metal or of its alloy (5) from portions (2c) not covered by the protective layer (7) and optionally removing the second adhesion layer (4b) from said portions (2c) if the second adhesion layer (7) is made from the same noble metal or the same noble metal alloy as the layer of noble metal or of its alloy (5);
removing the protective layer (7); and
removing the first adhesion layer (4a) and optionally the second adhesion layer (4b) if the latter is still present after removing the layer of noble metal or of its alloy (5) on the portions (2c).

2. The manufacturing method according to claim 1, in which the first adhesion layer (4a) is formed from a layer of Cr or of Ti and the second adhesion layer (4b) is formed of Au, of Ag or of Cu and in which the first adhesion layer (4a) and the second adhesion layer (4b) are deposited by PVD.

3. The manufacturing method according to claim 1, in which the first adhesion layer (4a) and the second adhesion layer (4b) each have a thickness comprised between 30 and 70 nm and in which the layer of the noble metal or of its alloy (5) has a thickness comprised between 0.02 mm and 0.7 mm, preferably between 0.03 mm and 0.3 mm.

4. The manufacturing method according to claim 1, comprising an additional step in which a micro-perforation (6a), an engraving (6b) and/or a sunken relief (6c) is carried out prior to depositing a first adhesion layer (4a) and a second adhesion layer (4b), said micro-perforation (6a), engraving (6b) and/or sunken relief (6c) being anchoring points for the relief decoration (2a).

5. The manufacturing method according to claim 1, comprising an additional mechanical operation step on the upper part (5a) of the layer of the noble metal or of its alloy (5) in order to polish, satin-finish and/or matt said layer (5).

6. The manufacturing method according to claim 1, in which the step of removing the layer of noble metal or of its alloy (5) is carried out in a cyanide bath.

7. The manufacturing method according to claim 1, in which the step of removing the protective layer (7) is carried out in a solvent bath.

8. The manufacturing method according to claim 1, in which the step of removing the first adhesion layer (4a) and optionally the second adhesion layer (4b) is carried out in a commercial bath.

9. A part (1) comprising at least one relief decoration (2a) overlying a base surface (2b), said relief decoration (2a) being made of a noble metal or its alloy and having a thickness comprised between 0.02 mm and 0.7 mm, preferably between 0.03 mm and 0.3 mm, said relief decoration (2) being joined to the base surface (2b) by a first adhesion layer (4a) and by a second adhesion layer (4b) each having a thickness comprised between 30 and 70 nm.

10. The part (1) according to claim 9, in which said relief decoration (2a) and the first and second adhesion layers (4a, 4b) open into a micro-perforation (6a), an engraving (6b) and/or a sunken relief (6c) carried out in the base surface (2b).

11. The part (1) according to claim 9, said part (1) being a horology component.

12. The part (1) according to claim 11, said part (1) being a bezel or a dial.

13. The part (1) according to claim 9, said part (1) being made of ceramic or sapphire, silicon nitride or YAG.
